(19) United States
(12) Patent Application Publication
(10) Pub. No.: US 2021/0012296 A1
(43) Pub. Date: Jan. 14, 2021

(54) Network Extended Support System

(71) Applicant: Commercial Electronics, Inc., Gate City, VA (US)

(72) Inventor: Robert C. Blevins, Gate City, VA (US)

(21) Appl. No.: 16/507,009

(22) Filed: Jul. 9, 2019

(51) Int. Cl. G06Q 10/00

(52) U.S. Cl. CPC G06Q 10/20

(57) ABSTRACT

Apparatus and methods for tracking and maintaining geographically separated electrical equipment. An identifier attached to a piece of equipment allows each piece of equipment to be identified and tracked. The identifier is scanned or otherwise input into a reader where a data record is created or updated with the equipment's specific information. A mobile device with a scanner and display allows the equipment to be tracked as it moves between locations and when it is installed or maintained a final, installed destination. The method includes the steps of receiving, storing, deploying, and maintaining piece of equipment while maintaining a data record of the equipment's status. Maintenance records and data provide information on root causes for maintenance, including causes related to specific individuals associated with such equipment and causes related to specific types, models, and/or manufacturers of equipment.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND

### 1. Field of Invention

This invention pertains to a system and method for tracking and maintaining geographically separated electrical equipment. More particularly, this invention pertains to a system and method for tracking and maintaining equipment as it moves between a warehouse, a final destination, and a repair destination, while keeping a history of installation and repair events.

### 2. Description of the Related Art

Internet service providers, telephone service providers, and cable service providers typically require electrical equipment be placed at various locations as part of their infrastructure and also at the subscriber's location in order to access the services offered by the providers. These subscribers include both consumers and commercial enterprises. To maximize profitability, the pieces of equipment need to remain in service as long as possible, along with being efficiently repaired and/or replaced when required.

Inventory control systems are commonly used to track inventory as it moves through a warehouse or other storage facility. Typically, such inventory control systems track inventory used within a single system as the inventory moves and follows a process for its handling, such as for manufacturing or for sales. But inventory control systems are unsuitable for tracking and maintaining geographically separated electrical equipment such as used by service providers, such as Internet service providers, telephone service providers, and cable service providers, and the equipment providers that contract installation and maintenance to these providers. Inventory control systems also do not allow for tracking and analyzing equipment maintenance and failures. Current systems are labor intensive and subject to errors because the involved parties resist expending the necessary effort to keep up with the equipment spread over a wide area.

### BRIEF SUMMARY

According to one embodiment of the present invention, systems and methods for tracking and maintaining geographically separated electrical equipment are provided. The systems and methods are suitable for tracking and maintaining thousands of pieces of equipment that move between multiple locations that are not under control of a single entity and where the locations are separated geographically and/or are mobile locations, such as repair or service trucks. A unique identifier is associated with each piece of equipment. The equipment is tracked by scanning or reading the unique identifier when the equipment is processed during various events. Such events include receiving the equipment initially, storing the equipment, removing the equipment from storage, transporting the equipment, installing the equipment, servicing and/or maintaining the equipment in place, repairing the equipment at a repair facility, and, finally, retiring the equipment. Recording data associated with these events allows various parties to mine the accumulated data to better manage the equipment and personnel working on that equipment.

An advantage of the present system and method is that a large number of pieces of equipment can be efficiently tracked with an accurate data record using readily available mobile devices. Mobile or portable devices with a camera or other input device operate as readers of the identifier affixed to pieces of equipment. The devices allow for entry of data specific to the piece of equipment.

Another advantage of the present system and method is that data record includes information pertinent to each piece of equipment, including that the piece of equipment needs to be repaired, the failure mode and the repairs made if repair is needed, and the personnel who installed and maintained the equipment. For example, the data record includes the present location of each piece of equipment where such equipment is widely distributed over a wide geographical area. The data record includes status information on the piece of equipment, such as its current condition, for example, and whether repair or replacement is required.

Another advantage of the present system and method is that an equipment provider is able to access the data records to determine where the equipment is located and where equipment is needed.

Another advantage of the present system and method is that a service provider is able to access the data records to determine what equipment requires service or maintenance and where replacement equipment is available and needed. Yet another advantage of the present system and method is that the service provider is able to determine failure rates and determine trends of failures and maintenance activities.

Another advantage of the present system and method is that a customer is able to access the data records of equipment in the customer's possession.

The system includes a unique identifier for each piece of equipment, both stationary and mobile readers, a data storage unit, and both stationary and mobile data access devices. Each unique identifier is attached to a piece of equipment to be tracked. The unique identifier is associated with a data record for the piece of equipment.

The unique identifier is input into various stationary and/or mobile readers. For example, when the piece of equipment is received in a warehouse, the unique identifier is affixed to the piece of equipment and a reader reads the unique identifier and stores the unique identifier information in the data storage unit, along with a data record containing information associated with the piece of equipment. When the piece of equipment is loaded into a service truck for installation at a particular site, the unique identifier is scanned or read and the data record is updated with information about the vehicle in which the piece of equipment is loaded. When the piece of equipment arrives at an installation location, the unique identifier is scanned or read and the data record is updated with information about the location in which the piece of equipment is installed. When the piece of equipment is removed from an installation location for repair or replacement, the unique identifier is scanned or read and the data record is updated with information about the status of the piece of equipment.

In one embodiment, the data storage unit is a centralized data processing system that receives the data record when created and received updated status and other information on the piece of equipment. The data storage unit also delivers the data record to stationary and mobile data access devices as requested by those devices.

The stationary and mobile data readers and display devices allow the identity, location, and other information to be recorded as the piece of equipment is being handled. The historical information regarding each piece of equipment is maintained in real time with the ready availability of portable devices that allow reading the unique identifier and the entry and/or display of associated data. The portable devices allow for querying the data records for one or more specific pieces of equipment, which allows easily locating replacement parts and aiding troubleshooting of failed equipment.

### BRIEF DESCRIPTION OF THE SEVERAL VIEWS OF THE DRAWINGS

The above-mentioned features will become more clearly understood from the following detailed description read together with the drawings in which:

FIG. 1 is a symbolic drawing of one embodiment of an equipment tracking system.

FIG. 2 is a flow diagram of one embodiment of the life cycle of a piece of equipment.

FIG. 3 is a flow diagram of one embodiment of the method of updating the status of the piece of equipment.

FIG. 4 is a flow diagram of one embodiment of the step of storing the equipment.

FIG. 5 is a flow diagram of one embodiment of the step of deploying.

FIG. 6 is a flow diagram of one embodiment of the step of maintaining.

FIG. 7 is a flow diagram of one embodiment of the method for accessing the collection of data records.

### DETAILED DESCRIPTION

Apparatus and methods for tracking and maintaining geographically separated electrical equipment is disclosed. The equipment tracking and maintaining system 100 allows for handling a piece of equipment that is generally indicated as 102. Various pieces of equipment are illustrated both generically and specifically in the figures and in the following description. For example, a piece of equipment 102-A, 102-B, 102-C is discussed individually and separately to ensure clarity when describing the location of each piece of equipment 102-A, 102-B, 102-C. The piece of equipment 102 is referenced without the alphanumeric suffix when referred to generally regardless of location.

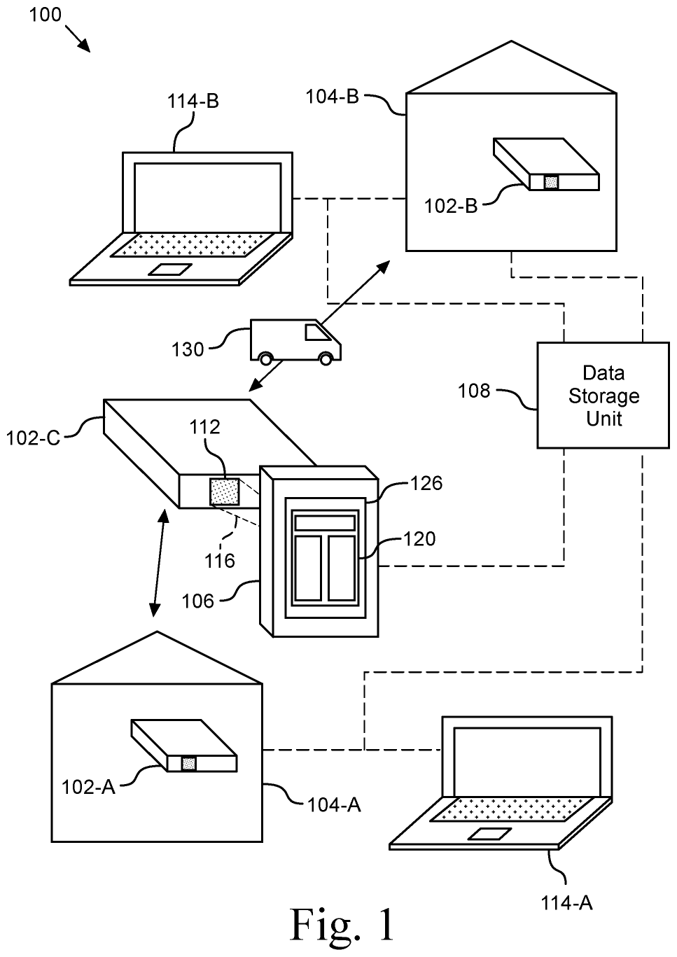

FIG. 1 illustrates a symbolic drawing of one embodiment of an equipment tracking system 100. The equipment tracking system 100 includes a unique identifier 112 for each piece of equipment 102, stationary readers 114-A, 114-B and mobile readers 106, a data storage unit 108, and stationary data access devices 114-A, 114-B and mobile data access devices 106. In one embodiment, the readers and data access devices 114, 106 are incorporated in devices that perform both the reading, or input, functions and the access and display functions.

FIG. 1 illustrates a piece of equipment 102-A that is located in a first facility 104-A. That same piece of equipment 102-B is movable so as to be located in a second facility 104-B. That same piece of equipment 102-C is transportable between various facilities 104, such as when the equipment 102-C is stored or moving in a delivery or service vehicle 130. To aid in the discussion, the first facility 104-A is considered a warehouse and the second facility 104-B is a customer's location, which is the final destination of the equipment 102-B where the equipment 102-B is placed in service. The equipment 102-C is moved between the facilities 104 by the vehicle 130.

As used herein, a piece of equipment 102 refers to an electronic device. Such devices are commonly used by Internet service providers, telephone service providers, and cable service providers. The equipment 102 is often part of the infrastructure of the various providers, such as routers, switches, network access points, and servers. In some cases the equipment 102 includes modems and routers used to connect customer or subscriber devices to the provider's infrastructure. Generally, the equipment 102 requires installation, maintenance, and service over its expected operating life.

Each piece of equipment 102 includes an identifier 112. The identifier 112 is a unique identifier, such as a serial number assigned by a manufacturer or other identifier that is affixed to the equipment 102 to uniquely identify the equipment 102 in the system 100. In various embodiments, the identifier 112 is a bar code, a QR code, a series of machine-readable and/or human-readable alpha-numeric characters, or a machine-readable RFID or similar device. The identifier 112 is entered into the system 100 by way of a reader 106, 114. In one embodiment, a portable reader 106 has a field of view 116 in which the reader 106 reads the identifier 112 to obtain the unique identification for that piece of equipment 102. The identifier 112 information is stored in a data record 120, which is then stored in a data storage unit 108. In other embodiments, the user enters the information from the identifier 112 manually into the reader 106, 114.

The devices 114-A, 114-B, 106, in one embodiment, perform two functions. One function is as a reader that acquires information from the identifier 112 and allows data on the piece of equipment 102 to be entered by the user. Another function is as an access and display device that gets information on one or more pieces of equipment 102 from the data storage unit 108. In one embodiment, the devices 114, 106 are portable devices such as smart phones, tablets, or laptops that include a camera, RFID reader, or bar code reader and a user interface. In such an embodiment, anyone with a device 106 and who has access rights is able to use the system 100. In another embodiment, the devices 114 are stationary or semi-permanent devices, such as desktop computers or special devices incorporated onto conveyors or other equipment handling machines. In such an embodiment, the devices 114 are special purpose devices configured and intended to be used in one location or position.

The data record 120 is a construct that contains information regarding a piece of equipment 104. The data record 104 is created when a new piece of equipment 104 is received, such as described in the step 304 of FIG. 3. Once the data record 120 is created, the data record 120 is populated with information specific to the piece of equipment 102, such as a description of the equipment, a manufacturer and/or model number, a version number of software and/or firmware, and other specifications and information. The data record 120 also includes location and status information, which, when associated with a date and/or time, provides history information for the piece of equipment 102.

In the illustrated embodiment, each facility 104 has available a stationary-type reader 114-A, 114-B, which, in various embodiments is any type of device used within that facility 104. Devices 114 associated with each facility 104 allow for reading or inputting the identifier 112 into the system 100 and for displaying or retrieving the data record 120 for a piece of equipment 102. In various embodiments, the device 114-A, 114-B is a mobile device such as a smart phone or tablet, a laptop, a desktop computer, or other device capable of reading the identifier 112, sending the information from the identifier 112 to a data storage unit 108, and retrieving and displaying a data record 120.

Shown in FIG. 1 is a data storage unit 108, which includes a database containing tables storing the data records 120 collected equipment tracking system 100. The data storage unit 108 is in communication with the various readers and displays 114, 106. In various embodiments, the data storage unit 108 is any of various devices known in the art for storing data, such as, but not limited to, a file server, a hard disk, a network attached storage device (NAS), recordable optical disks, and/or a stand-alone networked data storage device.

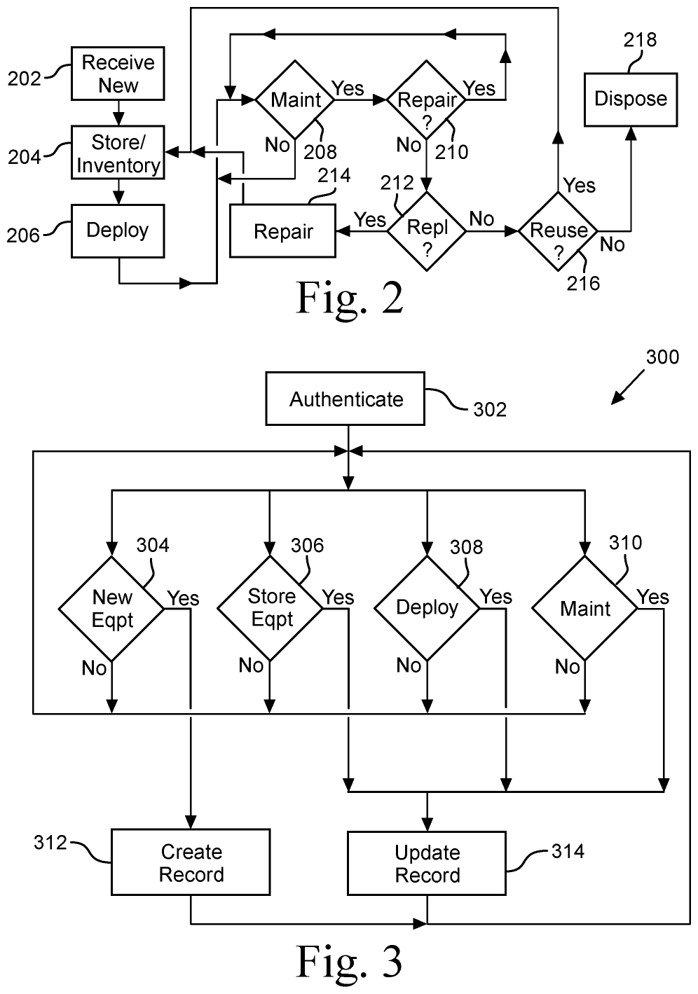

FIG. 2 illustrates a flow diagram of one embodiment of the life cycle of a piece of equipment 102. The illustrated flow diagram reflects how a piece of equipment 102 is physically handled from the perspective of an equipment provider. The flow diagrams of FIGS. 3-7 illustrate how a piece of equipment 102 is physically handled from the perspective of the whole system 100, including the personnel handling the equipment 102 and the devices 106, 108, 114 that collect, process, and display the data and actions associated with the equipment 102.

The first step 202 is to receive a new piece of equipment 102. A new piece of equipment 102 is one that has not yet been processed in the system 100 under the equipment's identifier 112. The step 202 of receiving includes either affixing an identifier 112 to the new equipment 102 or using an existing identifying tag, such as a unique identifier, serial number, or other identifying tag or label. The identifier 112 is read or input into a reader 102, 114 to create a new data record 120 that is then uploaded, transmitted, or otherwise transferred or saved to the data storage unit 108.

The next step 204 is to store or place into inventory the piece of equipment 102. This step 204 includes storing the piece of equipment 102-A in a facility 104-A such as a warehouse or in a vehicle 130 that would be used by a technician who installs and repairs equipment 102-B. Pieces of equipment 102-A are stored for later installation and use.

The next step 206 is to deploy the piece of equipment 102-A. This step 206 includes removing the equipment 102 from where it is stored 104, 130 and either installing the equipment 102 at a final destination facility 104-B or making the equipment 102 available for pickup by a customer. For example, when a piece of equipment 102 is to be deployed, it is removed from its storage facility 104-A, transported in a vehicle 130 to the location or facility 104-B where the equipment 102 is to be installed or placed in service. The final destination of the piece of equipment 102-B is the location or facility 104-B where the equipment 102 is placed in service for use.

The next step 208 after the step 206 of deploying is the step 208 to maintain the piece of equipment 102. The maintenance step 208 includes two checks: one for operability and another to determine if the equipment 102 is required to remain in service. The operability check of the maintenance step 208 includes checking the piece of equipment 102-B to ensure it is operating within its specifications. The required to remain in service check of the maintenance step 208 includes determining if the equipment 102-B is to be retired or removed from service, such as when a discontinuation of service to a customer occurs.

If the maintenance step 208 determines that neither condition has occurred, the step 208 loops back and is repeated until it is determined that the piece of equipment 102-B requires the step 210 of repair or removal. In various embodiments, step 208 includes a periodic check of the piece of equipment 102-B to ensure it remains operable. The periodic check is either an automatic check or a manual check or inspection. In another embodiment, step 208 includes a check when a customer or other person discovers an outage, a loss of service performance, or that the equipment 102-B is not performing within specification. In such an embodiment, the step 208 is performed upon manual instigation. In one embodiment, the system 100 initiates the maintenance step 208 by instructing a technician to remove the piece of equipment 102-B from service because it is no longer needed at that location 104-B.

If the maintenance step 208 determines that either repairing or retirement is necessary, the step 210 to repair in place the piece of equipment 102-B is performed after the maintenance step 208 determines that maintenance is required. If the maintenance step 208 determines that repair is needed, the repair step 210 includes troubleshooting to determine what is causing the problem that initiated the maintenance. If the troubleshooting performed during the repair step 210 determines that the piece of equipment 102-B is repairable in place, the repair step 210 includes repairing the equipment 102-B. The repair step 210 also includes recording or logging the observed problems and if there is any physical damage, missing parts, wrong parts, water damage, power surge damage, and/or any other type of issue with the equipment 102.

If the repair step 210 is successfully performed, it loops back to the start of the maintenance step 208. If the repair step 210 determines that the equipment 102-B cannot be repaired in place, the next step 212 is to determine if replacement or retirement is required.

If the piece of equipment 102-B cannot be or is not required to be repaired in place, the next step 212 is to determine if replacement of the installed piece of equipment 102-B is required. If the replacement step 212 determines that the equipment 102-B needs to be replaced, the step 212 includes requesting a new piece of equipment 102 from the system 100. In such a case, a second piece of equipment 102-A is deployed 206 to replace the failed piece of equipment 102-B. In one such case, the equipment 102-B remains out of service until the second piece of equipment 102-A is deployed 206 from a remote facility 104-A. In another such case, the second piece of equipment 102-A is deployed 206 from a delivery or service vehicle 130 in which the second piece of equipment 102-A is stored for immediate use as a replacement.

The failed piece of equipment 102-B is repaired during the repair step 214. The repair step 214 includes moving the piece of equipment 102-B to a repair facility 104, repairing the piece of equipment 102, and then transporting the equipment to a storage facility 104-A or vehicle 130 where step 204 is repeated for the repaired piece of equipment 102. The repair step 214 also includes recording or logging any observed problems and if there is any physical damage, missing parts, wrong parts, water damage, power surge damage, and/or any other type of issue with the equipment 102.

If the replacement step 212 determines that the piece of equipment 102-B is not to be replaced, the next step 216 is to determine if the equipment is to be reused by returning it to storage 104-A such that step 204 is repeated for the piece of equipment 102. If step 216 determines that the equipment 102-B is not suitable to be reused, step 218 disposes of the piece of equipment 102-B. The disposal step 218 removes the piece of equipment 102-B from the system 100.

FIG. 3 illustrates a flow diagram of one embodiment of the method of updating 300 the status of the piece of equipment 102. In one embodiment, the method 300 of updating the status of a particular data record 120 is implemented by the system 100 such as illustrated in FIG. 1.

The first step 302 is to authenticate the person or user accessing the system 100. One purpose of the authentication step 302 is to identify the person performing the work for the next steps 304, 306, 308, 310. Generally, the person performing the work, such as an equipment handler, a driver or delivery person, an installer, and/or a repair or maintenance person, is the person that is also accessing the system 100 to record the data. For example, a technician performing the maintenance step 310 at a facility 104 scans the identifier 112, inspects and tests the equipment 102, and performs the actions required by the step 310. In this way, the technician performing the work is automatically identified and recorded in step 302. For the case where the person being authenticated is not the same person doing the work, the authentication step 302 includes recording the name or other identifier of the person doing the work.

After the step 302 of authentication, the next steps 304, 306, 308, 310 are performed as selected by the user if the user has permission as determined in the authentication step 302. If no steps are selected, the method 300 loops back to the step 302 of authentication. In the illustrated embodiment, the loop returns to the output of the authentication step 302. In another embodiment, the loop returns to the start and the authentication step 302 must be repeated to continue the method 300.

Generally a service provider receives, processes, and handles pieces of equipment 102. Personnel under the control of the service provider perform the method 300 steps. The authentication step 302 requires that a user enter authentication information into the reading and/or display devices 106, 114 before being permitted to continue. The step 302 for authentication uses the entered authentication information to determine if the user has permission to continue. If the user has permission to perform one or more of the steps 304, 306, 308, 310, the user continues, otherwise the user is blocked from continuing beyond the authentication step 302 until the user enters authentication information that allows continuation. For example, a receiver, or receiving, clerk processes new pieces of equipment 102 and performs the operations flowing from step 304. For such a receiver clerk, during the authentication step 302, that receiver clerk has permission to perform steps 304 and 312 and is restricted from performing other steps 306, 308, 310, 314 by the authentication step 302.

Selecting step 304 for a new piece of equipment 102 entails performing the step 312 of creating a data record 120 for the new equipment 102. Affixing an identifier 112 to the new equipment 102 if a unique identifier, serial number, or other identifying tag is not already on the equipment 102 is performed under either the new equipment step 304 or the creating record step 312. The creating record step 312 includes reading or inputting the identifier 112 information into a reader 102, 114 to create a new data record 120 that is then uploaded or transmitted to or saved in the data storage unit 108.

Selecting step 306 of storing the location of the equipment 102 entails performing step 314 of updating the record 120 with the current location information. The step 306 of selecting to store the equipment 102 includes putting the piece of equipment 102 in an identified facility 104-A, 104-B or vehicle 130. The step 314 of updating the record 120 includes reading the identifier 112 with a reader 106, 114 to update an existing data record 120 that is at the data storage unit 108. The step 314 also includes updating the data record 120 with information on the location 104-A, 104-B, 130. The location information, in various embodiments, is determined by accessing information from a global positioning system (GPS) device that is part of the reader 106, 114 or by the user causing the location information to be added to the data record 120.

Selecting step 308 of deploying the equipment 102 entails performing step 314 of updating the record 120 with the current information regarding the disposition of the equipment 102. For example, when a piece of equipment 102-B is moved to a customer's or final destination facility 104-B, a technician or other person installs the equipment 102-B and places it in service. In another example, a piece of equipment 102 is deemed ready for pickup by a customer for the customer to install and place the equipment 102-B in service.

Selecting step 310 of maintaining the equipment 102 entails performing step 314 of updating the record 120 with the current information regarding the disposition of the equipment. For example, when a technician goes to a facility 104-B, such as a customer's location, to troubleshoot a problem, the technician may determine that a piece of equipment 102-B needs to be repaired in place, removed and replaced, removed and sent out for repairs, or removed and retired. Maintenance step 310 includes determining any observed problems and if there is any physical damage, missing parts, wrong parts, water damage, power surge damage, and/or any other type of issue with the equipment 102. Maintenance step 310 also includes tracking the person performing the maintenance, all replacement parts and components, and the type of repair performed. The update record step 314 records the information determined and tracked during the maintenance step 310.

After step 314 is performed, the method 300 loops back to the step 302 of authentication. In the illustrated embodiment, the loop returns to the output of the authentication step 302. In another embodiment, the loop returns to the start and the authentication step 302 must be repeated to continue the method 300.

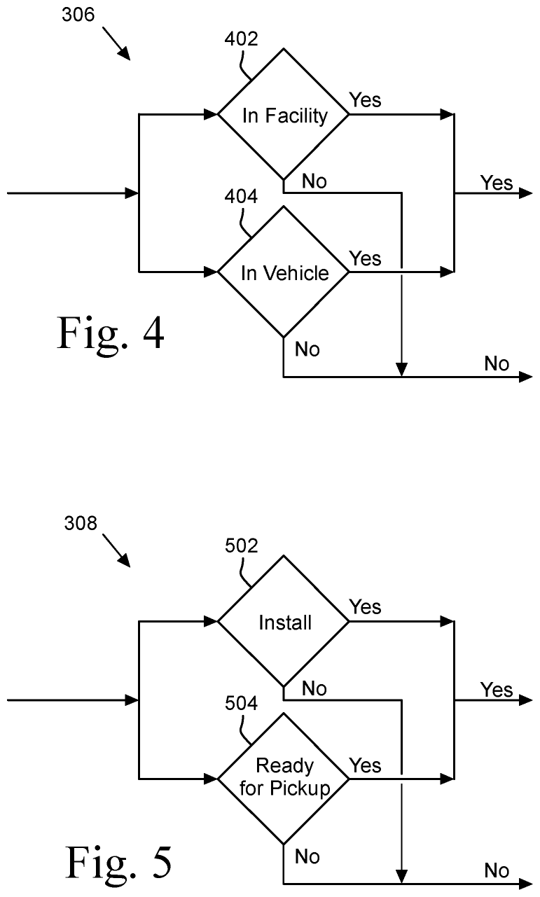

FIG. 4 illustrates a flow diagram of one embodiment of the step 306 of storing the equipment 102 at a location, such as in an identified facility 104-A, 104-B or in an identified vehicle 130. Step 306 includes the step 402 of selecting a facility 104 and the step 404 of selecting a vehicle 130. These two steps 402, 404 are both performed in any order or by actively selecting only the pertinent step 402, 404. In another embodiment, the steps 402, 404 are performed sequentially, for example, the storing in vehicle step 404 is performed only if the storing in facility step 402 is determined to be not applicable.

Step 402 of selecting storing a piece of equipment 102 in a facility 104-A, 104-B includes identifying the piece of equipment 102-A, 102-B and identifying the facility 104-A, 104-B.

Step 404 of selecting storing a piece of equipment 102 in a vehicle 130 includes identifying the piece of equipment 102-A, 102-B and identifying the specific vehicle 130 in which the equipment 102 is being carried or stored for transport.

In various embodiments, the steps 402, 404 include accessing information from a GPS device that is part of the reader 106, 114 or by the user causing the facility 104 or vehicle 130 information to be added to the data record 120, such as by recording the location or the reader 106, 114 automatically recording the location. In both steps 402, 404, the identity of the piece of equipment 102-A, 102-B and location of the facility 104 or vehicle 130 is written to the data record 120, along with the date and time.

FIG. 5 illustrates a flow diagram of one embodiment of the step 308 of deploying the equipment 102. The step 308 of deploying includes the step 502 of selecting to install and the step 504 of selecting ready for pickup. These two steps 502, 504 are performed in any order or by actively selecting only the pertinent step 502, 504. In another embodiment, the steps 502, 504 are performed sequentially, for example, the ready for pickup step 504 is performed only if the install step 502 is determined to be not applicable.

Step 502 of determining to install the piece of equipment 102-B at a facility 104-B includes identifying the piece of equipment 102-A, 102-B and identifying the facility 104-B.

Step 504 of determining that the piece of equipment 102-B is ready for a customer to pickup for installation by the customer at the customer's facility 104-B includes identifying the piece of equipment 102-A, 102-B and identifying the current location 104, 130 of the piece of equipment 102, the identity of the customer, and the facility 104-B where the equipment is to be ultimately installed and/or placed in service.

In various embodiments, the steps 502, 504 include accessing information from a GPS device that is part of the reader 106, 114 or by the user causing the facility 104 or vehicle 130 information to be added to the data record 120, such as by recording the location or the reader 106, 114 automatically recording the location. In both steps 502, 504, the information collected is written to the data record 120, along with the date and time.

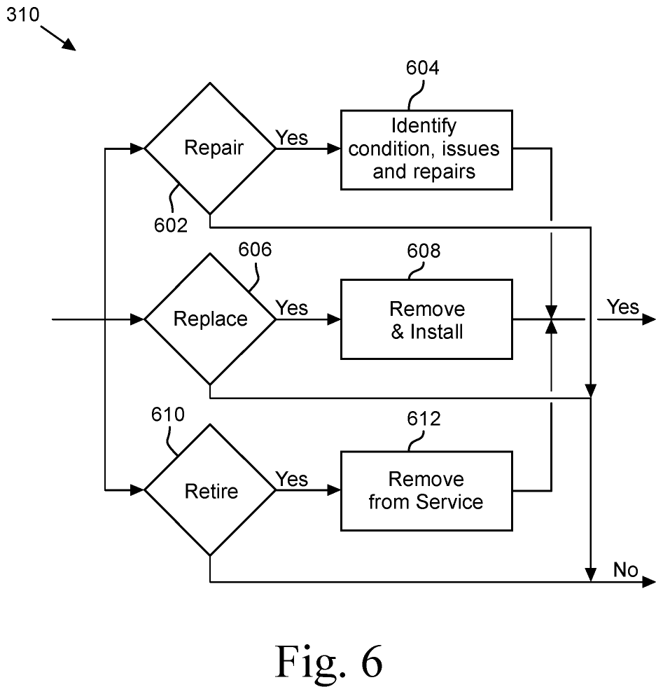

FIG. 6 illustrates a flow diagram of one embodiment of the step 310 of maintaining the equipment 102. The step 310 of maintenance includes a technician, repair person, or someone else inspecting the piece of equipment 102 and determining if the step 602 of selecting to repair, the step 606 of selecting to replace, or the step 610 of retiring the piece of equipment 102 is warranted. These three steps 602, 606, 610 are performed in any order or by actively selecting only the pertinent step 602, 606, 610. In another embodiment, the steps 602, 606, 610 are performed sequentially, for example, the selecting to replace step 604 is performed only if the selecting to repair step 602 is determined to be not applicable, and so on.

One way of performing step 310 is for a technician, repair person, or someone else to go to a facility 104-B where the equipment 102-B is located. At that location 102-B the technician or other person troubleshoots to determine if a problem exists and how to correct the problem.

Step 602 of determining to repair a piece of equipment 102-B includes the technician identifying the piece of equipment 102-B, identifying the facility 104-B, and identifying the problem and/or the corrective action necessary to repair the piece of equipment 102-B. In some cases, the repair step 602 is performed in place at the facility 104-B. In other cases, the repair step 602 includes diagnosing the issue, transporting the equipment 102-B to a repair facility 104 where it is repaired. In such a case, the repair step 602 is performed in conjunction with the replace step 606. That is, the failed equipment 102-B is determined to need repair in step 602 and is then replaced in step 606. After the equipment 102-B is repaired, it is returned to inventory or back to service via step 606. Step 604 includes identifying and noting the condition, the issues and problems observed and repaired, and the details of the repair, such as components replaced and corrective actions taken. Each technician or person performing repair step 602 identifies under step 604 the data noted by that person, and that data is then used to update the record 314.

Step 606 of determining to replace a piece of equipment 102-B includes the technician identifying the piece of equipment 102-B, identifying the facility 104-B, and identifying the problem and that the necessary corrective action is to remove the piece of equipment 102-B and replace it. Step 608 to remove and install the replacement piece of equipment 102-B is then performed. In one embodiment, the step 608 includes identifying a suitable replacement based on its proximity to the location 104-B and specifications. For example, step 608 includes querying the data records 120 in the data storage unit 108 to determine if a suitable replacement is in the technician's vehicle 130 or at a nearby facility 104-A. After locating a suitable replacement, step 308 (and step 502) are performed for the piece of equipment 102-B installed as a replacement.

Step 610 of determining to retire a piece of equipment 102-B includes the technician identifying the piece of equipment 102-B, identifying the facility 104-B, and identifying that the piece of equipment 102-B is not required and can be removed from service without a replacement. Step 612 to remove the piece of equipment 102-B from service is then performed.

In various embodiments, the steps 602, 606, 610 include accessing information from a GPS device that is part of the reader 106, 114 or by the user causing the facility 104 or vehicle 130 information to be added to the data record 120, such as by recording the location or the reader 106, 114 automatically recording the location. In steps 602, 606, 610, the information collected is written to the data record 120, along with the date and time.

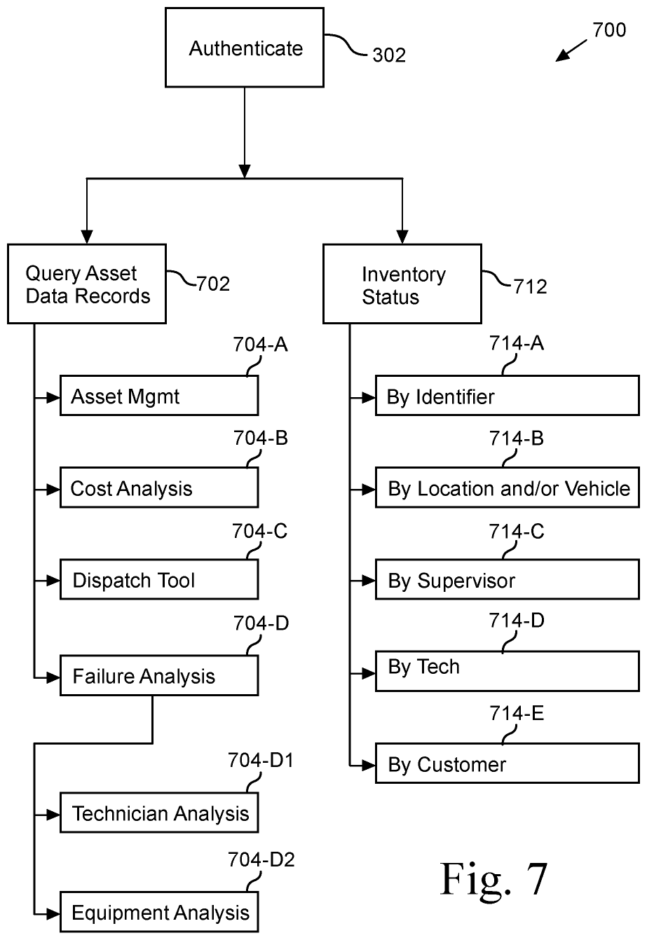

FIG. 7 illustrates a flow diagram of one embodiment of the method 700 for accessing the collection of data records 120. In one embodiment, the method 700 of accessing the collection of data records 120 is implemented by the system 100 such as illustrated in FIG. 1.

The first step 302 is to authenticate the person or user accessing the system 100. After the step 302 of authentication, the next steps 702, 712 are performed as selected by the user if the user has permission as determined in the authentication step 302.

Generally a service provider handles pieces of equipment 120. In other embodiments, customers of the service provider have permission to access certain data related to pieces of equipment 120, particularly that equipment 120 under control of the customer or at the customer's facility 104-B. The authentication step 302 requires that a user enter authentication information into the reading and/or display devices 106, 114 before being permitted to continue. The step 302 for authentication uses the entered authentication information to determine if the user has permission to continue. If the user has permission to perform one or more of the steps 702, 704, 712, 714, the user continues, otherwise the user is blocked from continuing beyond the authentication step 302 until the user enters authentication information that allows continuation. For example, a customer wishes to see what equipment is located at the customer's facilities 104-B and how many, if any, pieces of equipment 102-B are out of service. The customer performs the authentication step 302 by entering authentication information into a reading and/or display device 106, 114. The authentication step 302 includes determining that the customer has certain permissions and allows the customer to select steps 712, 714-E to access information on equipment 102-B related to that customer. The authentication step 302 denies the customer access to the other steps of the method 700.

Step 702 allows a user to query asset data records, that is, the step 702 offers a menu of options 704 for examining and analyzing data stored in the data storage unit 108. Generally, the personnel of the equipment provider have permission to access the options 714, although, restrictions based on job function may apply. For example, managers of the equipment provider have access to all options 704 available while certain personnel of the equipment provider have restricted permission or access rights based on their job function.

One such option is the step 704-A of accessing asset management tools. Asset management tools allow the equipment provider to query the data records 120 in the data storage unit 108 for various purposes, including conducting audits, verifying data in the records 120, and other methods for data analysis of the equipment 102, either individually or collectively, based on definable characteristics, such as location, equipment specs, etc.

Another option is the step 704-B of accessing a cost analysis tool. The cost analysis tools allow the equipment provider to query the data records 120 in the data storage unit 108 for various purposes, including analyzing the data records 120 with respect to aiding in keeping cost and financial control over the pieces of equipment 102 and their handling.

Another option is the step 704-C of accessing a dispatch tool that allows for querying, analyzing, and specifying equipment 102 that is available to be used as new equipment 102 and as replacements for failed or retired equipment 102. The dispatch option 704-C provides information and aids in routing equipment 102 to locations 104 where the equipment 102 can be best or more efficiently used.

Another option is the step 704-D of performing failure analysis for the pieces of equipment 102 that have been identified as having failed or requiring repair, replacement, or retirement. The failure analysis tool allows for determining trends or root causes or other reasons why the equipment 102 has failed or required replacement. A root cause is a factor that caused the failure or problem, where, if the root cause were corrected, similar failures and/or problems would be prevented. That is, the root cause is the highest level cause of a problem. The root cause is the core issue that set in motion the entire cause-and-effect reaction that ultimately led to the failure or problem. By identifying the root cause and eliminating it, similar failures and/or problems would be prevented. The root cause may be related to a specific person, the training of one or more persons, a specific piece of equipment 102, or other equipment 102 and/or personnel issues.

In various embodiments, the system 100 stores data on personnel working on the equipment, the observed physical damage, missing parts, wrong parts, water damage, power surge damage, and/or any other type of issue. The system 100 also stores data on repairs and maintenance performed, including if the observed problem matches what was repaired. Stored data includes the details of the repair such as replaced and/or repaired components, required cleaning, and proper use, installation, and maintenance of the equipment 102. The results of the failure analysis step 704-D allows for identifying issues with personnel, environment, and/or equipment.

One type of failure analysis 704-D is an analysis 704-D1 focusing on personnel issues and performance. The technician analysis 704-D1 includes identifying pieces of equipment 102 that are associated with a specific individual or technician to determine if there is a common cause for failure or requiring repair or replacement. Personnel issues may require resolution by training identified persons in the proper setup of equipment 102, proper enclosure installation or storage, proper powering and installation of equipment 102, proper installation of add-ons and extra devices, and/or proper handling of equipment 102 and tools.

Another type of failure analysis 704-D is an analysis 704-D2 focusing on equipment issues and performance. Equipment issues include problems associated with equipment where those problems are not tied to personnel. For example, equipment problems include issues caused by environment or underperforming equipment. Environment issues may require resolution by training identified persons in the proper location selection, setup, and installation of equipment 102. Environment issues may require resolution by identifying equipment 102 that is unsuitable for specific environments, facilities 104, and/or locations with that information provided as part of the deploying step 206. Equipment issues may be resolved by identifying issues common with specific models or manufacturers of equipment 102, or with specific customers, facilities 104, and/or applications.

Another option is the step 704-E of performing a technician analysis for the pieces of equipment 102 that have been identified as being associated with a specific individual or technician. having failed or requiring repair, replacement, or retirement. The results of the technician analysis step 704-E allows for identifying issues with personnel, such as when specific individuals have a history of equipment 102 that has failed or required maintenance, particularly when a common cause of such failures or maintenance is identified where such common cause is associated with some activity or behavior of the individual. Personnel issues may require resolution by training identified persons in the proper setup of equipment 102, proper enclosure installation or storage, proper powering and installation of equipment 102, proper installation of add-ons and extra devices, and/or proper handling of equipment 102 and tools.

Step 712 allows a user to view inventory status for the pieces of equipment 102 tracked by the system 100. That is, the step 712 offers a menu of options 714 for examining and viewing data stored in the data storage unit 108. Generally, the personnel of the equipment provider have permission to access the options 714, although, restrictions based on job function may apply. For example, the equipment provider management has permission to access all options 714 while the equipment provider technicians have permission to access on the option to view equipment 102 stored in the technician's vehicle (option 714-B) or under the control of that technician (option 714-D).

One such option is the step 714-A of accessing inventory status by the identifier 112 associated with a piece of equipment 102. This option 714-A queries the data storage unit 108 to provide the data record 130 for a specific piece of equipment 102.

Another option is the step 714-B of accessing inventory status by the location, such as the facility 104 or vehicle 130, of the equipment 102. This option 714-B queries the data storage unit 108 to provide the data records 130 for pieces of equipment 102 stored at a particular facility 104-A, 104-B or in a particular vehicle 130.

Another option is the step 714-C of accessing inventory status by the equipment provider supervisor who is associated with pieces of equipment 102, such as the equipment 102 stored at locations 104 under the responsibility of the supervisor or equipment 102 associated with particular technicians under the control of the supervisor.

Another option is the step 714-D of accessing inventory status by the technician or personnel who is associated with pieces of equipment 102. The personnel reporting step 714-D allows for determining if there is a problem or issue with the job performance of individual personnel. For example, if a technician is associated with installing equipment that has a high failure or maintenance rate, corrective action may be warranted. If equipment 102 installed by one individual has a failure rate above a threshold, that individual is trained on proper techniques to avoid such failures. Data considered during the personnel reporting step 714-D includes identifying if reporting of the observed condition and/or problem does not match the condition and/or problem identified during repair, if the equipment suffered water damage, if the equipment suffered power surge damage, if there were missing or wrongly installed parts and devices, and/or if there was physical damage to the equipment. In these cases, the corrective action is to train the individual responsible for the identified issues.

Another option is the step 714-E of accessing inventory status by a customer. For example, a customer of the equipment provider is able to access inventory status 714-E for the equipment under control of the customer, such as the equipment 102 stored at locations 104 owned by or under the control of the customer.

In one embodiment, each of the functions identified in FIGS. 3-7 are performed by one or more software routines executed in one or more of the readers and display devices 104-A, 114-B, 106 and/or the data storage unit 108. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

From the foregoing description, it will be recognized by those skilled in the art that a system and method for keeping up with an electronic inventory of pieces of equipment 102 located in multiple locations 104, 130 has been provided. Both the equipment provider and the customer are able to keep up with the equipment 102 that they have control over. In particular, the system and method aids in tracking and reporting on the maintenance requirements of equipment 102 using devices 114, 106.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method for tracking and maintaining geographically separated electrical equipment, said method comprising the steps of:
a) associating an identifier with a piece of equipment selected from a plurality of equipment;
b) creating a data record for said piece of equipment with said identifier uniquely identifying said piece of equipment associated with said data record;
c) storing said piece of equipment at a first location described in said data record;
d) installing said piece of equipment at a second location described in said data record;
e) determining if said piece of equipment requires maintenance and adding a description of said required maintenance to said data record after verifying said identifier of said piece of equipment; and
f) determining a disposition of said piece of equipment that requires maintenance, where said step of determining said disposition includes step f1) of determining a root cause for the required maintenance.

2. The method of claim 1 wherein said step f1) of determining said root cause includes the step of correlating a plurality of causes requiring maintenance with a plurality of individuals where each one of said plurality of individuals is responsible for at least one of said plurality of causes.

3. The method of claim 1 wherein said step f1) of determining said root cause includes the step of correlating a plurality of causes requiring maintenance with a plurality of types of said plurality of equipment.

4. The method of claim 1 further including a step g) of repairing said piece of equipment and updating a status of said data record, said step g) of repairing performed after said step f) of determining a disposition when said disposition is determined to be to repair said piece of equipment.

5. The method of claim 1 further including a step g) of accessing said data record to identify if said piece of equipment requires maintenance.

6. The method of claim 1 wherein said steps a) through f) are performed for each one of said plurality of equipment.

7. The method of claim 6 further including a step g) of accessing information regarding which ones of said plurality of equipment require maintenance.

8. The method of claim 6 further including a step g) of accessing information regarding which ones of said plurality of equipment are at said first location.

9. The method of claim 6 further including a step g) of accessing information regarding which ones of said plurality of equipment are at said second location.

10. A method for tracking and maintaining geographically separated electrical equipment, said method comprising the steps of:
a) maintaining a plurality of data records wherein each data record contains information specific to a corresponding one of a plurality of equipment;
b) updating said plurality of data records to reflect status information of said corresponding one of a plurality of equipment, wherein said status information includes a location and a failure status; and
c) retrieving said plurality of data records to produce a report identifying status information for said plurality of equipment.

11. The method of claim 10 further including a step d) of identifying a replacement for a selected one of said plurality of equipment that has a positive indication of said failure status.

12. The method of claim 10 further including a step d) retrieving said plurality of data records to produce a report identifying common issues with said plurality of equipment.

13. The method of claim 10 further including a step d) retrieving said plurality of data records to produce a report identifying an individual responsible for causing a common issue with said plurality of equipment.

14. The method of claim 10 wherein said step c) of retrieving said plurality of data records includes a step of producing a failure analysis from selected ones of said plurality of equipment that have a positive indication of said failure status.

15. The method of claim 10 wherein said step c) of retrieving said plurality of data records wherein said report is filtered by at least one of said location.

16. The method of claim 10 wherein said step c) of retrieving said plurality of data records wherein said report is filtered by at least one of said location wherein said location is a vehicle.

17. The method of claim 10 wherein said steps b) and c) are restricted to users who have been granted permission to update and retrieve said plurality of data records.

18. An apparatus for tracking and maintaining geographically separated electrical equipment, said apparatus comprising:
a plurality of identifier tags, each one of said identifier tags being unique to each one of a plurality of equipment;
a plurality of data records, each one of said data records containing information associated with a specific one of said plurality of identifier tags;
a data storage unit storing said plurality of data records;
a first device in communication with said data storage unit, said first device responsive to said plurality of identifier tags, said first device storing an identifier, a first location, and a first status associated with each one of said plurality of identifier tags, said first device having a first user interface for updating and displaying a specific one of said plurality of data records that is associated with said specific one of said plurality of identifier tags; and
a second device in communication with said data storage unit, said second device responsive to said plurality of identifier tags, said first device storing said identifier, a second location, and a second status associated with said each one of said plurality of identifier tags, said second device having a second user interface for updating and displaying said specific one of said plurality of data records that is associated with said specific one of said plurality of identifier tags.

19. The apparatus of claim 18 wherein said first device produces a report of selected ones of said plurality of data records, wherein said selected ones include those data records that contain a positive failure status, said positive failure status derived from one of said first and second status.

20. The apparatus of claim 18 wherein said first device produces a report of selected ones of said plurality of data records, wherein said selected ones include those data records associated with said plurality of equipment that are at said first location.
